(19) United States
(12) Patent Application Publication
(10) Pub. No.: US 2026/0115872 A1
(43) Pub. Date: Apr. 30, 2026

(54) CONFIGURATION OF TIGHTENING TOOL

(71) Applicant: ATLAS COPCO INDUSTRIAL TECHNIQUE AB, Stockholm (SE)

(72) Inventors: Staffan ALDENFALK JANSSON, Solna (SE); Jason BENFORD, Troy, MI (US)

(73) Assignee: ATLAS COPCO INDUSTRIAL TECHNIQUE AB, Stockholm (SE)

(21) Appl. No.: 19/134,847

(22) PCT Filed: Nov. 15, 2023
(86) PCT No.: PCT/EP2023/081891

§ 371 Date: Jun. 2, 2025

(30) Foreign Application Priority Data
Dec. 9, 2022 (SE) 2230405-9

(51) Int. Cl. B25B 21/00; B25B 23/147

(52) U.S. Cl. CPC B25B 21/008; B25B 23/147

(57) ABSTRACT

Provided is a method and device for determining a configuration of a tightening tool. The method comprises acquiring a set of observed values of a property of a tightening performed by the tool and affecting a clamp force of a fastener to which a tightening operation is applied, removing any observed values from the set representing non-allowable values applied to the fastener during the tightening operation, determining that the set of observed values from which the non-allowable values have been removed complies with a normal distribution, determining that a spread metric based on standard deviation of the normal distribution is within an allowed range and setting lower and upper allowable values for said property for a tightening operation to be applied by the tightening tool based on at least one of the standard deviation and mean value of the normal distribution.

### TECHNICAL FIELD

The present disclosure relates to a method of a device of determining a configuration of a tightening tool, and a device performing the method.

### BACKGROUND

In industrial applications, various types of tools are utilized for facilitating and aiding work. For instance, automated tightening tools are employed for tightening structural joints using fasteners such as e.g. bolts, nuts, studs or screws. In such environment, these tools are a necessity for providing sufficiently high quality and tightening force in the tightening process.

When tightening a joint, it is crucial to control the tightening operation provided by the tool. This may be undertaken in many ways, e.g. with torque control, angle control, or by measuring the elongation of the bolt during the tightening process, also known as clamp force control.

A problem occurring during the tightening process is that there are several undesired tightening results that may occur for the bolt or screw being tightened, such as e.g. a bolt being incorrectly tightened resulting in a slightly too great or slightly too small clamp force at the joint. This problem occurs both upon an operator manually handling the tightening tool as well as in applications here the tightening process is fully automated.

### SUMMARY

One objective is to solve, or at least mitigate, this problem in the art and to provide an improved method of determining a configuration of a tightening tool.

This objective is attained in a first aspect by a method of a device of determining a configuration of a tightening tool. The method comprises acquiring a set of observed values of a property of a tightening performed by the tool and affecting a clamp force of a fastener to which a tightening operation is applied, removing any observed values from the set representing non-allowable values applied to the fastener during the tightening operation, determining that the set of observed values from which the non-allowable values have been removed complies with a normal distribution, determining that a spread metric based on standard deviation of the normal distribution is within an allowed range, and setting lower and upper allowable values for said property for a tightening operation to be applied by the tightening tool based on at least one of the standard deviation and mean value of the normal distribution.

This objective is attained in a second aspect by a device configured to determine a configuration of a tightening tool. The device comprises a processing unit operative to cause the device to acquire a set of observed values of a property of a tightening performed by the tool and affecting a clamp force of a fastener to which a tightening operation is applied, remove any observed values from the set representing non-allowable values applied to the fastener during the tightening operation, determine that the set of observed values from which the non-allowable values have been removed complies with a normal distribution, determine that a spread metric based on standard deviation of the normal distribution is within an allowed range, and to set lower and upper allowable values for said property for a tightening operation to be applied by the tightening tool based on at least one of the standard deviation and mean value of the normal distribution.

Advantageously, by removing any values in the set which represent non-allowable property values (the property being embodied by e.g. tightening angle or torque) applied to the object during the tightening operation, any values representing a tightening property below an allowable lower limit or above an allowable upper limit are removed to avoid any future configuration limits being affected negatively by outliers.

Thus, both the lower allowable property value and the upper allowable property value will advantageously be set based on acquired historical property values having been appropriately applied during tightening operations, and accurate configuration of the tool is undertaken.

In an embodiment, the spread metric is within the allowed range if the standard deviation is below a selected threshold value.

In an embodiment, the spread metric is within the allowed range if three standard deviations are less than the mean value.

In an embodiment, the upper allowable value for said property is set to one of a) the mean value of the normal distribution plus a selected number, b) the mean value of the normal distribution plus a selected number of standard distributions or c) the mean value of the normal distribution multiplicated by a selected factor plus a selected number of standard distributions.

In an embodiment, the upper allowable value for said property is set to the highest of values a), b) or c).

In an embodiment, the lower allowable value for said property is set to the mean value of the normal distribution multiplicated by a selected factor minus a selected number of standard distributions, if that results in the lower allowable value exceeding a selected minimum value.

In an embodiment, the lower allowable value for said property is set to the mean value of the normal distribution minus the selected number of standard distributions, if that results in the lower allowable value exceeding the selected minimum value.

In an embodiment, the lower allowable value for said property is set to the mean value divided by two, if the mean value divided by two exceeds two standard deviations and the mean value exceeds a further selected minimum value.

In an embodiment, the lower allowable value for said property is set to the mean value divided by two, if the mean value divided by two does not exceed the further selected minimum value.

In an embodiment, the property of the tightening performed by the tool and affecting clamp force of a fastener is torque or angle applied by the tightening tool to the fastener.

In an embodiment, the upper allowable value is set further away from a mean value as compared to the lower allowable value.

In an embodiment, a new set of observed values of the property is acquired and new lower and upper allowable values are computed based on the new values, wherein in case there is a deviation of a currently set lower allowable value from the newly computed lower allowable value which exceeds an appropriately selected first threshold value and/or if there is a deviation of a currently set upper allowable value from the newly computed upper allowable value which exceeds an appropriately selected second threshold value, an indication is given that the lower and upper allowable values should be set using the newly computed lower and upper allowable values.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 shows a tightening tool for which embodiments may be implemented;

FIG. 2 shows a flowchart illustrating a method of a device of determining a configuration of a tightening tool according to an embodiment;

FIG. 3 shows a flowchart illustrating a method of a device of determining a configuration of a tightening tool according to a further embodiment; and

FIG. 4 shows a flowchart illustrating a method of a device of determining a configuration of tightening tool according to yet a further embodiment.

### DETAILED DESCRIPTION

The aspects of the present disclosure will now be described more fully hereinafter with reference to the accompanying drawings, in which certain embodiments of the invention are shown.

These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

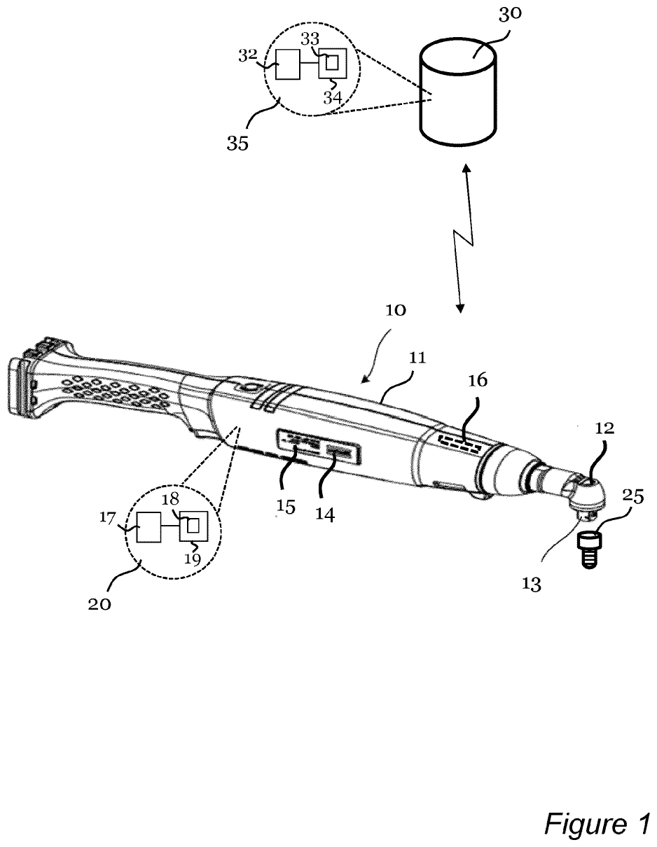

FIG. 1 illustrates an industrial tool in the form of a tightening tool 10 configured to apply a torque to a fastener such as a bolt 25 for tightening a joint, for which tool embodiments may be implemented.

The tightening tool 10 may be cordless or electrically powered via a cord and has a main body 11 and a tool head 12. The tool head 12 has an output shaft 13 with a socket (not shown) configured to be rotatably driven by an electric motor arranged inside the main body 11 to apply the torque to the bolt 25.

The tightening tool 10 may be arranged with a display 14 via which an operator of the tool 10 may be presented with information relating to operation of the tool 10, and an interface 15 via which the operator may input data to the tool 10.

The tightening tool 10 may further be arranged with communicating capability in the form of a radio transmitter/receiver 16 for wirelessly transmitting operational data, such as applied torque, to a remotely located controller such as a cloud server 30. Alternatively, communication between the tool 10 and the controller 30 may be undertaken via a wired connection.

Thus, the tool 10 may for instance communicate measured operational data to the controller 30 for further evaluation while the controller 30 e.g. may send operational settings to be applied by the tool 10 or instructions to be displayed to the operator via the display 14, or even automatically configure the tool 10. As is understood, the method of determining a configuration of the tool 10 according to embodiments may be performed in the tool 10 or in the cloud server 30 (or even in combination where some steps are performed in one device and others are performed in the other). Thus, the tool 10 is typically equipped with a control device 20 and the cloud server 30 comprises a similar control device 35 housing the same or similar data processing components, as will be described in the following.

The steps of the method to be described in the following as performed by the tool 10 and/or the cloud server 30 are in practice performed by a control device 20 and 35, respectively, comprising a processing unit 17, 32 embodied in the form of one or more microprocessors arranged to execute a computer program 18, 33 downloaded to a storage medium 19, 34 associated with the microprocessor, such as a Random Access Memory (RAM), a Flash memory or a hard disk drive. The processing unit 17, 32 is arranged to cause the tool 10 and/or cloud server 30 to carry out the method according to embodiments when the appropriate computer program 18. 33 comprising computer-executable instructions is downloaded to the storage medium 19, 34 and executed by the processing unit 17, 32. The storage medium 19, 34 may also be a computer program product comprising the computer program 18, 33. Alternatively, the computer program 18 may be transferred to the storage medium 19, 34 by means of a suitable computer program product, such as a Digital Versatile Disc (DVD) or a memory stick. As a further alternative, the computer program 18, 33 may be downloaded to the storage medium 19, 34 over a network. The processing unit 17, 32 may alternatively be embodied in the form of a digital signal processor (DSP), an application specific integrated circuit (ASIC), a field-programmable gate array (FPGA), a complex programmable logic device (CPLD), etc. The control device 20, 35 is communicatively connected to the interface for external communication, for instance from the tool 10 to the cloud server 30 and vice versa.

The control device 20 may be arranged inside the tightening tool 10 or in connection to the tool 10, for instance as a control device 20 attached to an external side of the main body 11 of the tool 10.

As previously mentioned, when using a tightening tool 10, it is important that the applied clamp force is accurate, i.e. the force that holds a bolted joint together. The applied clamp force is dependent on tightening properties of the tightening tool 10 such as the torque being applied by the tool 10 to the bolt 25, as well as the applied tightening angle where, once the joint is seated, a full round of rotation of the bolt 25 corresponds to 360° while a half round of rotation corresponds to a tightening angle of 180°, and so on. The final clamp force is highly dependent on the tightening angle being applied during a tightening operation.

Thus, a tightening tool 10 is typically preconfigured with lower and upper limits for the torque and angle being applied during a tightening operation. When the torque and/or angle do not comply with these limits, the tightening operation is regarded as being not ok (NOK).

Assuming for instance that a maximum torque allowed to be applied by the tool 10 is preconfigured to, say, 100 Nm. A bolt 25 being tightened using a torque of e.g. 102 Nm is thus NOK. Typically, an operator of the tool 10 would be informed by means of e.g. a warning such as a flashing red lamp, and would need to retighten the bolt. Such tightening is thus classified as a not ok (NOK) bolt tightening.

It is hence important that the lower and upper limits for the tightening properties of the tool are carefully preconfigured. As mentioned hereinabove, it may be envisaged that the control device 35 of the cloud server 30 automatically preconfigures the tool 10 based on historical data,

This is resolved in an embodiment by utilizing historical tightening data to estimate lower and upper limits of future tightening operations.

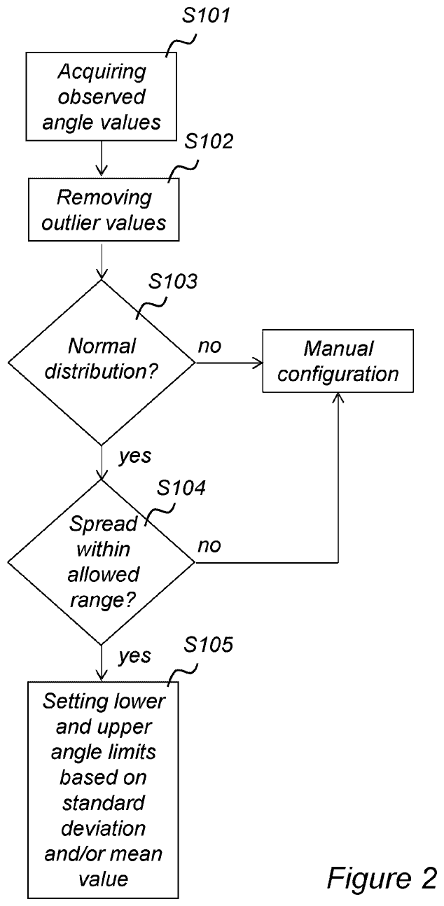

FIG. 2 illustrates a flowchart illustrating a method of determining a configuration of a tightening operation performed by a tightening tool in an embodiment.

While there are numerous tightening properties affecting clamp force of the fastener 25 to which a tightening operation is applied by the tool 10, the tightening property to be exemplified in the following is the angle of the applied tightening operation.

In a first step S101, a set of observed values is acquired of a tightening angle applied by the tool 10.

As is understood, this set may comprise hundreds or even thousands of values of angles having been applied by a tool 10 during a given time period. In an example, 800 angle values having been applied during the last 72 hours is acquired. In this example, these values are acquired at the tool 10 by the processing unit 17 and stored in local memory 19. For example, this set may be acquired during a pre-production configuration phase, wherein several test tightenings may be performed for the purpose of setting up the configuration of the tool 10 in preparation for a succeeding production process.

The following processing steps may be performed locally at the tool 10 by the processing unit 17 but may alternatively be sent wirelessly to the cloud server 30 over the interface 16 for processing. In this particular exemplifying embodiment, the steps are described as being performed by the processing unit 17.

In step S102, the processing unit 17 removes any values in the set which represent non-allowable angle values applied to the object during the tightening operation. In other words, outlier values representing NOKs are removed from the set. Advantageously, with this operation, any values representing tightening angles below an allowable lower limit or above an allowable upper limit are removed to avoid any future configuration limits being affected negatively by the outliers. The reduced set is stored in the memory 19.

There are various known methods of removing outliers from a distribution, such as e.g. Grubbs's test Chauvenet's criterion, Peirce's criterion, etc.

Thereafter, in step S103, the processing unit 17 determines whether or not the set of observed values from which the non-allowable values have been removed complies with a normal distribution. This may be performed using e.g. the well-known p-value hypothesis test.

If so, the processing unit 17 determines in step S104 whether or not a spread metric based on standard deviation of the distribution is within a allowed range.

In one embodiment, the processing unit 17 determines whether or not a standard deviation of the distribution is below a selected threshold value, i.e. σ<T. If so, the spread is sufficiently low and the spread metric is considered to be within the allowed range.

In another embodiment, the processing unit 17 determines whether or not three standard deviations are less than the mean value of the distribution is below a selected threshold value, i.e. 3*σ<mean value. If so, the spread is sufficiently low and the spread metric is again considered to be within the allowed range.

As is understood, both conditions may have to be satisfied for the spread metric to be considered to be within the allowed range, σ<T AND 3*σ<mean value. If none of the conditions are satisfied the tool 10 should be configured by an operator since the distribution cannot be relied upon for configuring the tool 10.

Finally, in step S105, lower and upper angle limits are set by the processing unit 17 based on either the standard deviation, the mean value or both. This will be discussed in detail in the following.

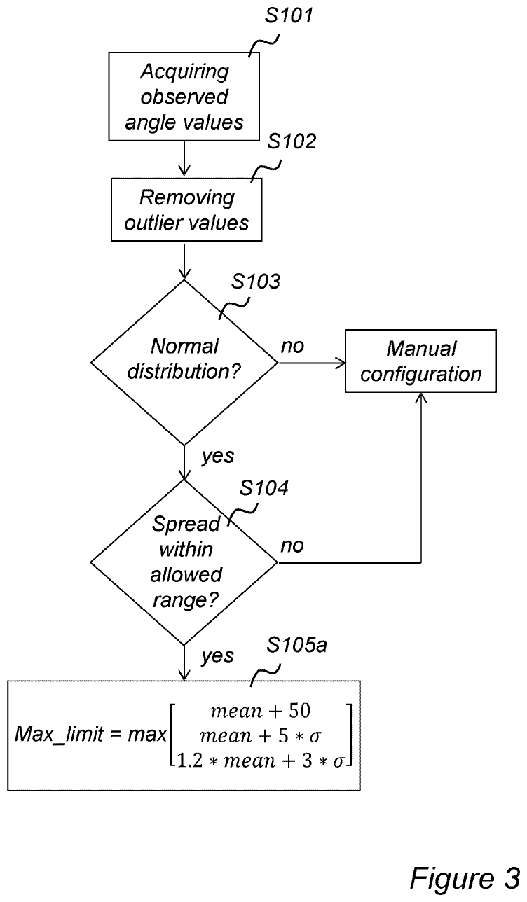

FIG. 3 illustrates a step S105a where an upper allowable angle value—Max_limit—to be applied by the tool 10 is set.

Thus, in a first embodiment, the upper allowable angle value is set to the mean value+50, where “50” in this example represents a carefully selected fixed value. The first embodiment may be most advantageous in a scenario where the mean value is close to zero (e.g. close to 20° in a practical situation) or at least relatively low, such as up to about 50°, since this allows setting of a limit that does not result in false NOKs caused by minor variations of the tightening. With a mean value of 20°, the upper allowable angle value would amount to 70° in this embodiment.

In a second embodiment, the upper allowable angle value is set to the mean value plus five standard deviations, i.e. mean value+5*σ. The second embodiment may be most advantageous in a scenario with medium-sized mean values, such as in the range 50°-150°. The second embodiment may be more advantageous in a scenario with a relatively low mean since it is affected more by σ. Using a measure of 5*σ will typically result in that the limits set only trigger for outliers/NOKs. For a normal distribution, there is approximately a risk of 1 in 3.500.000 that a value is located outside a range defined by the mean value+5*σ.

In a third embodiment, the upper allowable angle value is set to the mean value multiplicated by a selected factor plus three standard deviations, i.e. 1.2*mean value+3*σ. This is to take into account that the mean value has a tendency of shifting over time. The third embodiment may be most advantageous in a scenario with medium-sized to high mean values, such as from 100° and up. The third embodiment may be more advantageous in a scenario where the mean value is relatively large as compared to σ since false alarms caused the mean value shifting over time can be avoided.

In a further alternative, as shown in FIG. 3, the upper allowable angle value is set to the highest of the three values. Advantageously, this may reduce the number of false NOKs occurring by setting the angle limits too narrow.

As is understood, the upper allowable angle value may be rounded, such as e.g. to nearest ten.

The upper allowable angle value will often be set further away from the mean as compared to a lower allowable angle value (as will be described in the following), since an increase of the angle typically is not as critical as an decrease of the angle.

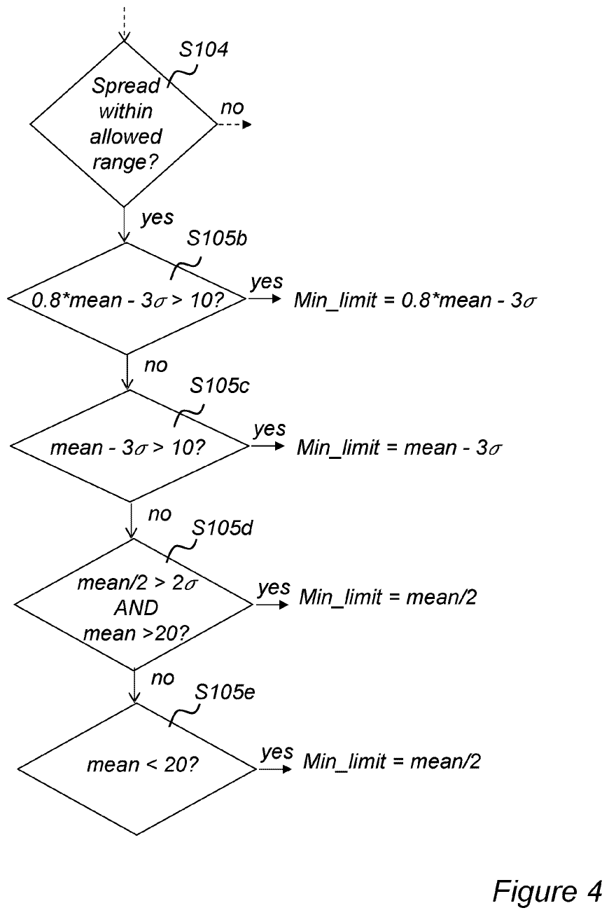

FIG. 4 illustrates steps S105b-e where a lower allowable angle value—Min_limit—to be applied by the tool 10 is set.

Thus, in a first embodiment, the lower allowable angle value is set in step S105b to the to the mean value multiplicated by a selected factor minus a selected number of standard deviations, i.e. 0.8*mean value−3*σ, given that the lower allowable angle value exceeds a selected minimum value (in this case 10). This is again to take into account that the mean value has a tendency of shifting over time. By setting the minimum value to 10, a value being meaningful for the tightening process is set. If for instance a minimum value of 2° would be set, an alert would in practice rarely be triggered.

As is well-known, for a normal distribution there is 99.7% chance that the values forming the distribution is located within a range defined by the mean value±3*σ.

In a second embodiment, the lower allowable angle value is set in step S105c to the mean value minus a selected number of standard deviations, i.e. mean value−3*σ, given that the lower allowable angle value exceeds the selected minimum value of 10.

In a third embodiment, the lower allowable angle value is set in step S105d to the mean value divided by 2, if the mean value divided by 2 exceeds a selected number of standard deviations (in this example 2) and the mean value exceeds a further selected minimum value of 20.

In a fourth embodiment, the lower allowable angle value is set in step S105e to the mean value divided by 2, also when the mean value exceeds the further selected minimum value of 20.

As is understood, the lower allowable angle value may be rounded, such as e.g. to nearest ten.

Thus, at this stage, both the lower allowable angle value Min_limit and the upper allowable angle value Max_limit have advantageously been set based on acquired historical angle values having been appropriately applied during tightening operations, and configuration of the tool 10 has been undertaken.

In other words, to configure the tightening tool 10 based on these determined lower and upper angle value limits would advantageously result in detecting NOKs that previously were not detected. The quality of the tightenings performed by the tool will thus increase.

Hence, these are the angle value limits that the tool 10 is to comply with when performing future tightening operations, and which are automatically set by the control device 35 of the cloud server 30 or even by the control device 20 of the tool 10 itself; the operator of the tool 10 does not need to perform manual configuration.

In a further embodiment, it is automatically detected if the current limits are incorrectly set.

Thus, assuming that a new set of 800 angle values is obtained and the method is run again for these new 800 angle values. If there is a deviation of the current lower limit from the new lower limit which exceeds an appropriately selected first threshold value and/or if there is a deviation of the current upper limit from the new upper limit which exceeds an appropriately selected second threshold value, an indication is given that the tool 10 should be reconfigured with the new computed lower and upper angle limits.

The aspects of the present disclosure have mainly been described above with reference to a few embodiments and examples thereof. However, as is readily appreciated by a person skilled in the art, other embodiments than the ones disclosed above are equally possible within the scope of the invention, as defined by the appended patent claims.

Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method performed by a device, for determining and setting a configuration of a tightening tool, comprising:
acquiring a set of observed values of a property of a tightening performed by the tool and affecting a clamp force of a fastener to which a tightening operation is applied;
removing any observed values from the set representing not ok (NOK) values applied to the fastener during the tightening operation;
determining that the set of observed values from which the NOK values have been removed complies with a normal distribution;
determining that a spread metric based on standard deviation of the normal distribution is within an allowed range; and
setting lower and upper allowable values for said property for a tightening operation to be applied by the tightening tool based on at least one of the standard deviation and mean value of the normal distribution.

2. The method of claim 1, wherein the spread metric is within the allowed range if the standard deviation is below a selected threshold value.

3. The method of claim 1, wherein the spread metric is within the allowed range if three standard deviations are less than the mean value.

4. The method of claim 1, where the upper allowable value for said property is set to one of: a) the mean value of the normal distribution plus a selected number, b) the mean value of the normal distribution plus a selected number of standard distributions or c) the mean value of the normal distribution multiplicated by a selected factor plus a selected number of standard distributions.

5. The method of claim 4, where the upper allowable value for said property is set to the highest of values a), b), or c).

6. The method of claim 1, where the lower allowable value for said property is set to the mean value of the normal distribution multiplicated by a selected factor minus a selected number of standard distributions, if that results in the lower allowable value exceeding a selected minimum value.

7. The method of claim 6, where the lower allowable value for said property is set to the mean value of the normal distribution minus the selected number of standard distributions, if that results in the lower allowable value exceeding the selected minimum value.

8. The method of claim 7, where the lower allowable value for said property is set to the mean value divided by two, if the mean value divided by two exceeds two standard deviations and the mean value exceeds a further selected minimum value.

9. The method of claim 8, where the lower allowable value for said property is set to the mean value divided by two, if the mean value divided by two does not exceed the further selected minimum value.

10. The method of claim 1, the property of the tightening performed by the tool and affecting clamp force of a fastener being torque or angle applied by the tightening tool to the fastener.

11. The method of claim 1, where the upper allowable value is set further away from a mean value as compared to the lower allowable value.

12. The method of claim 1, where a new set of observed values of the property is acquired and new lower and upper allowable values are computed based on the new values, wherein in case there is a deviation of a currently set lower allowable value from the newly computed lower allowable value which exceeds an appropriately selected first threshold value and/or if there is a deviation of a currently set upper allowable value from the newly computed upper allowable value which exceeds an appropriately selected second threshold value, an indication is given that the lower and upper allowable values should be set using the newly computed lower and upper allowable values.

13. A computer program comprising computer-executable instructions for causing a device to perform steps recited in claim 1 when the computer-executable instructions are executed on a processing unit included in the device performing the method.

14. A computer program product comprising a computer readable medium, the computer readable medium having the computer program according to claim 13 embodied thereon.

15. A device configured to determine and set a configuration of a tightening tool, the device comprising a processing unit operative to cause the device to:
acquire a set of observed values of a property of a tightening performed by the tool and affecting a clamp force of a fastener to which a tightening operation is applied;
remove any observed values from the set representing not ok ok (NOK) values applied to the fastener during the tightening operation;
determine that the set of observed values from which the NOK values have been removed complies with a normal distribution;
determine that a spread metric based on standard deviation of the normal distribution is within an allowed range; and
set lower and upper allowable values for said property for a tightening operation to be applied by the tightening tool based on at least one of the standard deviation and mean value of the normal distribution.
